(19) United States
(12) Patent Application Publication
(10) Pub. No.: US 2017/0318836 A1
(43) Pub. Date: Nov. 9, 2017

(54) ANIMAL CONSUMABLE HAVING REPLENISHMENT PROPERTIES

(71) Applicant: Jennifer Shayne Mackey, Pottstown, PA (US)

(72) Inventor: Jennifer Shayne Mackey, Pottstown, PA (US)

(21) Appl. No.: 15/586,127

(22) Filed: May 3, 2017

Related U.S. Application Data
(60) Provisional application No. 62/331,118, filed on May 3, 2016.

(51) Int. Cl. A23K 50/20; A23K 20/163; A23K 20/22; A23K 10/30

(52) U.S. Cl. CPC A23K 50/20; A23K 10/30; A23K 20/163; A23K 20/22

(57) ABSTRACT

A consumable having replenishment properties to be consumed by animals to maintain and/or restore proper hydration and electrolyte levels includes a base portion and an electrolyte portion. The base portion is processed by at least one of pureeing, juicing, liquefying and macerating. The base portion can include one or more of an item of produce. The base portion can be all-natural. The electrolyte portion can include one or more of a sugar, potassium and sodium. The electrolyte portion is combined with the base portion to generate the consumable. The consumable can also include a natural supplement such as vitamins, minerals and/or proteins. The consumable has a melting point and may be frozen prior to consumption or may be consumed in its liquid-like or slurry-like form.

### BACKGROUND

During summers or other periods of warm weather, or during times of excessive exercise, animals can easily get dehydrated and experience low levels of electrolytes just as humans do. For example, horses participating in horse shows, especially during the hot and/or humid summer months, can require excessive amounts of rehydration as well as cooling down. One method for quickly addressing these issues is by running a hose down the underside of the horse's throat because that cools down the jugular veins on either side of the throat, which cools down the blood the quickest. However, this method is unsatisfactory as far as trying to replenish any lost or depleted electrolytes. Thus, it is desired to develop other, more reliable methods to help animals, such as horses, maintain and/or restore proper hydration and electrolyte levels when subjected to such conditions.

### SUMMARY

The present invention is designed to maintain and/or restore proper hydration and electrolyte levels within animals when such levels become low for any reason. More specifically, the present invention is directed toward a consumable having replenishment properties for consumption by animals. In various embodiments, the consumable comprises a base portion and an electrolyte portion. The base portion can be processed to be provided in more liquid-like or slurry-like form. For example, in certain embodiments, the base portion can be at least one of pureed, juiced, liquefied and macerated. The electrolyte portion can also be mixed or combined with the base portion in a substantially homogeneous manner. The consumable has a melting point that is less than approximately 10 degrees Celsius. In certain embodiments, the consumable may be frozen prior to being consumed by animals. Alternatively, the consumable can be consumed in its liquid-like or slurry-like form, i.e., without being frozen.

In some embodiments, the base portion may include an item of produce.

Additionally, the base portion can be all-natural.

In various embodiments, the consumable includes an overall weight and/or an overall volume. In certain embodiments, the base portion comprises between approximately 60 percent and 90 percent of the overall weight of the consumable. In other embodiments, the base portion comprises greater than approximately 75 percent and less than approximately 95 percent of the overall volume of the consumable.

Additionally, in some embodiments, the electrolyte portion includes one of dextrose (or other sugars), potassium and sodium.

In certain embodiments, the electrolyte portion comprises greater than approximately 10 percent and less than approximately 40 percent of the overall weight of the consumable. In other embodiments, the electrolyte portion comprises greater than approximately 5 percent and less than approximately 25 percent of the overall volume of the consumable.

Further, in certain embodiments, the consumable can further comprise the addition of a nutritional supplement.

Additionally, the present invention is further directed toward a method for forming a consumable to be consumed by animals, the method comprising (i) processing a base portion, e.g., by at least one of pureeing, juicing, liquefying and macerating the item of produce; and (ii) combining an electrolyte portion with the processed base portion in a substantially homogeneous manner. The method may further comprise the consumable having a melting point that is less than approximately ten degrees Celsius.

Further, in certain applications, the present invention is directed toward a consumable for consumption by animals, the consumable having a melting point that is less than approximately 10 degrees Celsius, and including a base portion that gets processed, wherein the base portion has been at least one of pureed, juiced, liquefied and macerated, and wherein the base portion comprises between approximately 60 percent and 90 percent of the overall weight of the consumable, and an electrolyte portion that is combined with the base portion in a substantially homogeneous manner, wherein the electrolyte portion includes one of dextrose, potassium and sodium, and wherein the electrolyte portion comprises greater than approximately 10 percent and less than approximately 40 percent of the overall weight of the consumable.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified top view illustration of one embodiment of a consumable having replenishment properties and a base portion and an electrolyte portion that form the consumable having features of the present invention;

FIG. 2 is a simplified top view illustration of another embodiment of the consumable; and

FIG. 3 is a flowchart that illustrates one embodiment of a method for making the consumable.

### DESCRIPTION

Embodiments of the present invention are described herein in the context of a method for making a consumable having replenishment properties for animal consumption that can be effectively utilized for maintaining and/or restoring proper hydration and electrolyte levels of an animal (also sometimes referred to herein as “consumable”). Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

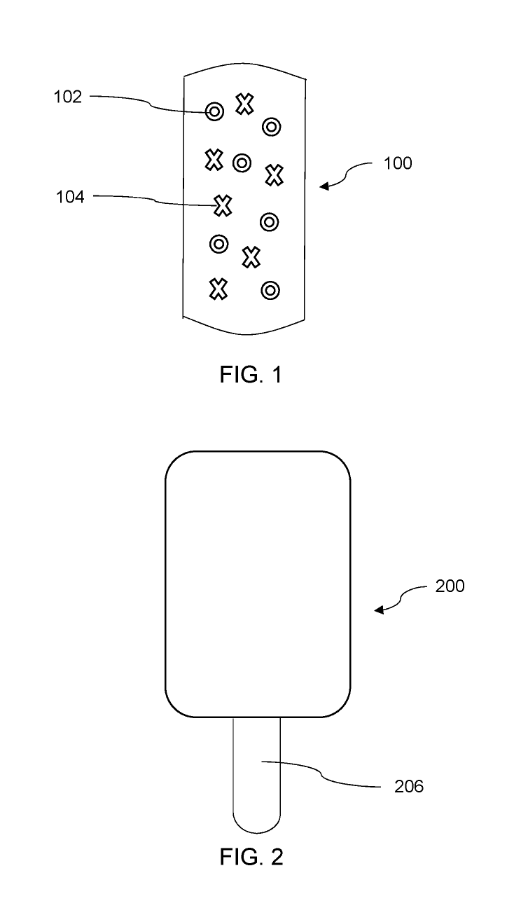

FIG. 1 is a simplified illustration of one embodiment of the consumable 100 and the base portion 102 and the electrolyte portion 104 that form the consumable 100. In this embodiment, the consumable 100, is in the shape or form of a rectangle or a bar, as one non-exclusive example. Alternatively, the consumable 100 may be of any suitable shape or form. In various embodiments the base portion 102 and the electrolyte portion 104 can be mixed or combined together homogeneously, such that the consumable 100 has a uniform appearance. In alternative embodiments, the base portion 102 and the electrolyte portion 104 may be mixed or combined together heterogeneously, i.e. in a non-homogeneous manner, such that the consumable 100 does not have the uniform appearance, but may visibly consist of different parts.

FIG. 2 is a simplified illustration of another embodiment of the consumable 200. In this embodiment, the consumable 200 is provided with a handle 206, e.g., a stick that makes the consumable 200 easier to handle while being consumed.

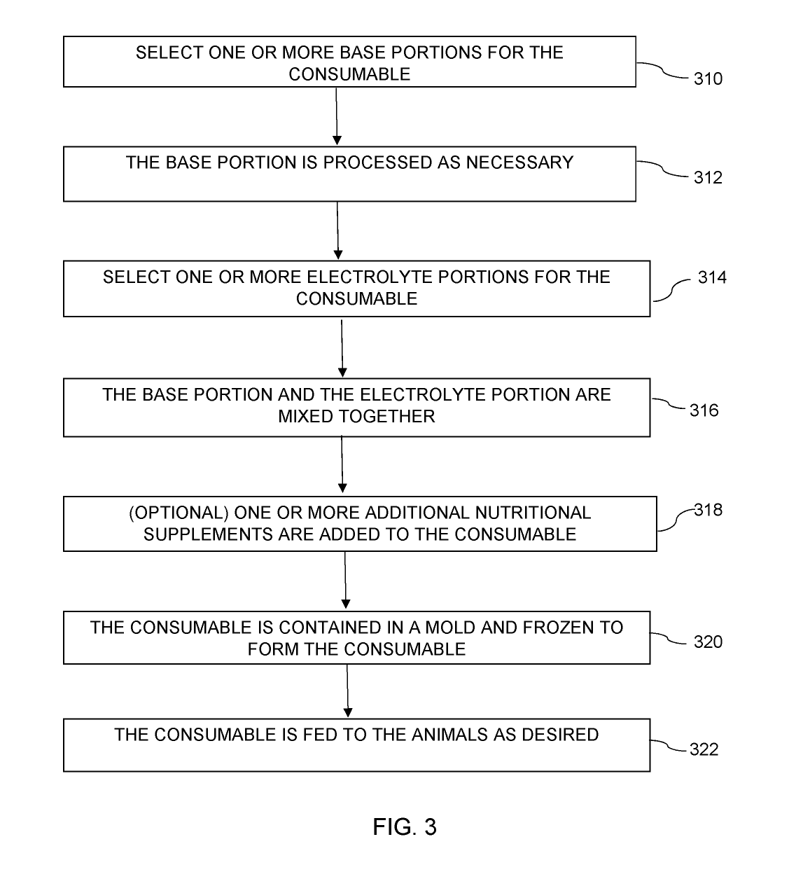

FIG. 3 is a flowchart that illustrates one embodiment of a method for making the consumable. Although the consumable is described herein primarily in its potential use with animals, it is appreciated that the consumable can also be utilized by humans.

It is understood that the various steps described herein can be modified as necessary in the process of making the consumable. Additionally, it should also be appreciated that in certain applications the order of the steps can be modified, certain steps can be omitted, and/or additional steps can be added without limiting the intended scope and breadth of the present invention.

At step 310, one or more base portions are selected for the consumable. In certain embodiments, the base portion may include an item of produce that is naturally grown, cultivated or harvested for consumption by animals and/or artificially generated or otherwise created. For example, in certain non-exclusive alternative embodiments, the item of produce can include one or more of an apple, a carrot, an orange, a strawberry, a pineapple, a banana, a watermelon, or peppermint. Alternatively, any other item of produce can be selected. It should be appreciated that the selection of the base portion can include the selection of one or more items of produce of the same type and/or can include the selection of multiple items of produce of different types. As such, any reference to a “base portion” can refer to a single item of produce and/or multiple items of produce.

In certain embodiments, the base portion can be formed from fresh, all-natural ingredients. For example, in such embodiments, all-natural ingredients can include items of produce that are not processed or do not contain added color, artificial flavors or synthetic substances. In other such embodiments, it is generally desired that any and all items of produce that are selected to form the consumable are all-natural and/or organic.

In various embodiments, the consumable may have an overall weight. The percentage of the overall weight of the consumable that is formed from the base portion can be varied to suit the specific requirements of the consumable. For example, in some embodiments, the base portion can comprise greater than approximately 60% and less than approximately 90% of the overall weight of the consumable. More particularly, in various alternative embodiments, the base portion can include at least approximately 60%, 65%, 70%, 75%, 80%, 85% or 90% of the overall weight of the consumable. Alternatively, the base portion can include greater than 90% or less than 60% of the overall weight of the consumable.

Additionally, in certain embodiments the consumable may have an overall volume. The percentage of the overall volume of the consumable that is formed from the base portion can also be varied to suit the specific requirements of the consumable. For example, in some embodiments, the base portion can comprise greater than approximately 75% and less than approximately 95% of the overall volume of the consumable. More particularly, in various alternative embodiments, the base portion can include at least approximately 75%, 80%, 85%, 90% or 95% of the overall volume of the consumable. Alternatively, the base portion can include greater than approximately 95% or less than approximately 75% of the overall volume of the consumable.

In step 312, the base portion is processed to the extent necessary, such that it can be more readily formed, combined and/or otherwise mixed into the consumable. More particularly, the base portion can be processed such that it is in a more liquid-like or slurry-like form. The means of processing the base portion can vary depending on the item of produce being utilized. For example, in certain embodiments, the means of processing the base portion can include one or more of juicing (e.g., through a pressing process), pureeing, liquefying, and macerating. Additionally and/or alternatively, the base portion can be processed via any other suitable method.

In step 314, one or more electrolyte portions are selected for the consumable. As noted above, warm weather and/or strenuous or excessive exercise can cause an animal to lose electrolytes, such that it can be desired to introduce additional electrolyte portions, i.e., to replace electrolytes, back into the system of the animal. Serious electrolyte disturbances, such as dehydration, may lead to cardiac and neurological complications that, unless rapidly resolved, could lead to a medical emergency.

An electrolyte is a substance that produces an electrically conducting solution when dissolved in a polar solvent, such as water. The dissolved electrolyte separates into cations and anions, which disperse uniformly through the solvent. A substance that dissociates into ions in solution acquires the capacity to conduct electricity. Electrolytes are important because they are what cells in the body (especially nerve, heart, and muscle cells) use to maintain voltages across their cell membranes and to carry electrical impulses (e.g., nerve impulses, muscle contractions, etc.) across themselves and to other cells.

In physiology, some of the major electrolytes include sodium (Na⁺), potassium (K⁺), calcium (Ca⁺²), magnesium (Mg⁺²), chloride (Cl⁻), phosphate (PO₄⁻²), sulfate (SO₄⁻²) and bicarbonate (HCO₃⁻). Thus, it is desired to maintain proper levels of each of such electrolytes at all times. During times of strenuous exercise, for example, an animal is most likely to lose the electrolytes of sodium and potassium. Sodium is the main electrolyte found in extracellular fluid and potassium is the main intracellular electrolyte. Both such electrolytes are involved in maintaining proper fluid balance, muscle function and blood pressure control. Thus, the reintroduction and/or replacement of sodium and potassium salts can replenish the body's water and electrolyte levels after dehydration caused by exercise.

The specific electrolyte portion selected for inclusion in the consumable, as well as the proportions of such electrolytes, can be varied depending on the specific requirements for the consumable. For example, in certain embodiments, the electrolyte portion can include one or more of dextrose, salt, potassium chloride, dicalcium phosphate, hydrophobic silica, and saccharin sodium. Further, in alternative embodiments, the electrolyte portion may include other types of sugars, including glucose, fructose, sucrose, lactose, maltose etc., as non-exclusive examples. Additionally, in some such non-exclusive alternative embodiments, the electrolyte portion can include greater than approximately 65% and less than approximately 80% of dextrose, greater than approximately 5% and less than approximately 10% of salt, greater than approximately 2% and less than approximately 5% of potassium, greater than approximately 1% and less than approximately 2% of calcium, and greater than approximately 0.5% and less than approximately 1% of phosphorous. Alternatively, the electrolyte portion can include more electrolytes or fewer electrolytes than those specifically listed above. Still alternatively, the percentages of any electrolytes selected can be different than, i.e. greater than or less than, those specific percentages listed above.

Additionally, the electrolyte portion can further incorporate one or more colorings or flavorings to make them look and taste more appealing when mixed or combined with the base portion to form the consumable. In maintaining the focus on providing all-natural consumables to the extent possible, such colorings or flavorings may be provided from all-natural sources, e.g., vegetable-based food colorings. Alternatively, artificial colorings and/or flavorings can also be used with the electrolyte portion.

The percentage of the overall weight of the consumable that is formed from the electrolyte portion can be varied to suit the specific requirements of the consumable. For example, in some embodiments, the electrolyte portion can include greater than approximately 10% and less than approximately 40% of the overall weight of the consumable. More particularly, in some such embodiments, the electrolyte portion can comprise at least approximately 10%, 15%, 20%, 25%, 30%, 35% or 40% of the overall weight of the consumable. Alternatively, the electrolyte portion can comprise greater than approximately 40% or less than approximately 10% of the overall weight of the consumable.

Additionally, the percentage of the overall volume of the consumable that is formed from the electrolyte portion can also be varied to suit the specific requirements of the consumable. For example, in some embodiments, the electrolyte portion can include greater than approximately 5% and less than approximately 25% of the overall volume of the consumable. More particularly, in some such embodiments, the electrolyte portion can comprise at least approximately 5%, 10%, 15%, 20% or 25% of the overall volume of the consumable. Alternatively, the electrolyte portion can comprise greater than approximately 25% or less than approximately 5% of the overall volume of the consumable.

In step 316, the base portion, as processed, is mixed, combined or formed together with the electrolyte portion to form a liquid-like or slurry-like consumable. In various embodiments the base portion and the electrolyte portion can be mixed or combined together homogeneously, such that the consumable has a uniform appearance. In alternative embodiments, the base portion and the electrolyte portion may be mixed or combined together heterogeneously, such that the consumable does not have the uniform appearance, but may visibly consist of different parts. However, it is understood that the mixing, combining or forming of the base portion and the electrolyte portion can be performed in any suitable manner.

In optional step 318, one or more additional nutritional supplements can be further added to the consumable. For example, depending on the specific animal that will consume the consumable, one or more specific vitamins, minerals, proteins, etc. can be further added into the consumable. It should be appreciated that any specific vitamins, minerals, proteins, etc. that may be added into the consumable can be varied to suit the specific needs of the particular animal that will consume the consumable. For example, any such nutritional supplements can include such vitamins, minerals, proteins, etc. that are normally included in the diet of the particular animal.

In step 320, the consumable may be contained in a mold and then frozen, e.g., flash frozen, to form the desired consumable. The mold can be of any suitable shape or design. As two non-exclusive examples the mold may be made of plastic or silicon. However, it is understood that the mold may be made from any suitable material. Alternatively, in certain embodiments, the consumable can be consumed in its liquid-like or slurry-like form, i.e. without freezing the consumable. Additionally, in some embodiments, a handle, such as a short stick, can be coupled to each of the consumables to make the consumable easier to handle when being consumed.

The temperature at which the consumable melts (also sometimes referred to herein as “melting point”) can be varied due to the different percentages of the base portion and the electrolyte portion contained within the consumable and to further suit the specific requirements of the consumable. For example, in some embodiments, the melting point of the consumable can be less than approximately −10° C. and greater than approximately 10° C. More particularly, in some such embodiments, the melting point can be at least approximately −10° C., −5° C., 0° C., or 5° C. or 10° C. Alternatively, the melting point can be greater than approximately 10° C. or less than approximately −10° C.

Finally, in step 322, the consumable, as finally formed, is fed to the animals as needed and/or desired. As provided herein, such consumables can be thus utilized in order to effectively maintain and/or replenish the fluids (i.e. hydration) and electrolyte levels with the body of the animal. Thus, the overall health of the animal can be better protected and maintained.

It is understood that although a number of different embodiments of the consumable 100 (and method for making thereof) have been illustrated and described herein, one or more features of any one embodiment can be combined with one or more features of one or more of the other embodiments, provided that such combination satisfies the intent of the present invention.

While a number of exemplary aspects and embodiments of the consumable 100 have been shown and disclosed herein above, those of skill in the art will recognize certain modifications, permutations, additions and sub-combinations thereof. It is therefore intended that the consumable shall be interpreted to include all such modifications, permutations, additions and sub-combinations as are within their true spirit and scope, and no limitations are intended to the details of construction or design herein shown.

What is claimed is:

1. A consumable for animals, the consumable comprising:
a base portion;
an electrolyte portion that is combined with the base portion in a substantially homogeneous manner; and
wherein the consumable has a melting point that is less than approximately 10 degrees Celsius.

2. The consumable of claim 1 wherein the base portion has been at least one of pureed, juiced, liquefied and macerated prior to being combined with the electrolyte portion.

3. The consumable of claim 1 wherein the base portion includes an item of produce.

4. The consumable of claim 1 wherein the base portion is all-natural.

5. The consumable of claim 1 wherein the consumable has an overall weight, and wherein the base portion comprises greater than approximately 60 percent and less than approximately 90 percent of the overall weight of the consumable.

6. The consumable of claim 1 wherein the consumable has an overall volume, and wherein the base portion comprises greater than approximately 75 percent and less than approximately 95 percent of the overall volume of the consumable.

7. The consumable of claim 1 wherein the electrolyte portion includes one of dextrose, potassium and sodium.

8. The consumable of claim 1 wherein the consumable has an overall weight, and wherein the electrolyte portion comprises greater than approximately 10 percent and less than approximately 40 percent of the overall weight of the consumable.

9. The consumable of claim 1 wherein the consumable has an overall volume, and wherein the electrolyte portion comprises greater than approximately 5 percent and less than approximately 25 percent of the overall volume of the consumable.

10. The consumable of claim 1 further comprising a nutritional supplement that is combined with the base portion and the electrolyte portion in a substantially homogeneous manner.

11. A method for manufacturing a consumable for animals, the method comprising the step of:
combining an electrolyte portion with a processed base portion in a substantially homogeneous manner so that the consumable has a melting point that is less than approximately ten degrees Celsius.

12. The method of claim 11 wherein the base portion is processed by one of pureeing, juicing, liquefying and macerating.

13. The method of claim 11 wherein the base portion includes an item of produce.

14. The method of claim 11 wherein the base portion comprises greater than approximately 60 percent and less than approximately 90 percent of an overall weight of the consumable.

15. The method of claim 11 wherein the base portion comprises greater than approximately 75 percent and less than approximately 95 percent of an overall volume of the consumable.

16. The method of claim 11 wherein the electrolyte portion includes one of dextrose, potassium and sodium.

17. The method of claim 11 wherein the electrolyte portion comprises greater than approximately 10 percent and less than approximately 40 percent of an overall weight of the consumable.

18. The method of claim 11 wherein the electrolyte portion comprises greater than approximately 5 percent and less than approximately 25 percent of an overall volume of the consumable.

19. The method of claim 11 further comprising the step of combining a supplement with the base portion and the electrolyte portion in a substantially homogeneous manner.

20. A consumable for animals, the consumable having an overall weight, the consumable comprising:
a base portion that has been at least one of pureed, juiced, liquefied and macerated, the base portion comprising greater than approximately 60 percent and less than approximately 90 percent of the overall weight; and
an electrolyte portion that is combined with the base portion in a substantially homogeneous manner, the electrolyte portion including one of dextrose, potassium and sodium, the electrolyte portion comprising greater than approximately 10 percent and less than approximately 40 percent of the overall weight;
wherein the consumable has a melting point that is less than approximately zero degrees Celsius.
